(19) United States
(12) Patent Application Publication
(10) Pub. No.: US 2002/0101988 A1
(43) Pub. Date: Aug. 1, 2002

(54) Decryption glasses

(76) Inventor: Mark A. Jones, Florham Park, NJ (US)

Correspondence Address: Mr. Brian S. Mudge, Kenyon & Kenyon, Suite 700, 1500 K Street, N.W., Washington, DC, 20005, US

(21) Appl. No.: 09/772,615

(22) Filed: Jan. 30, 2001

(51) Int. Cl. G09C 3/00

(52) U.S. Cl. 380/54

(57) ABSTRACT

A pair of optical decryption glasses having lenses that modify incident light emitted from a display so as to render encrypted images appearing on the display that are undecipherable to the naked eye, readable when the screen is viewed through the lenses. The lenses include either diffractive elements such as grating or prisms, or refractive elements. The optical decryption glasses have a unique registration number, and the optical properties of each pair glasses are also unique to the glasses and associated with its registration number. In a related embodiment, a pair of decryption glasses with processing capabilities is provided. The decryption glasses include an optical sensor, a processor and a display screen. The optical sensor receives images appearing on an external screen that have been encrypted to be undecipherable to the naked eye, and converts the received images into digital data. This data is sent to the processor where it is decrypted, allowing underlying messages to be deciphered and shown on the display screen.

### FIELD OF THE INVENTION

The present invention relates to providing privacy and security for commercial transactions.

### BACKGROUND OF THE INVENTION

Public kiosks, such as automatic teller machines are ubiquitous throughout the world. As the range of services offered by public kiosks broadens, it is anticipated that ever greater numbers of transactions will occur at such sites. Currently, transactions at public kiosks are secured and authenticated in various ways. In the case of a typical automatic teller machine, for example, transactions begin when a client places an identification card into a reception port and enters a password. If the entered password matches a stored password associated with the identification card number, then the client is authenticated and the transaction proceeds. The security risk presented by this example is the possibility of a replay attack by a third party who has observed the password as it was entered and who has obtained the identification card or a duplicate of the card.

To counter the danger of replay attacks, one-time passwords may be employed. Instead of inputting a permanent password at the start of each transaction, a set of calculated alphanumeric passwords is entered for a single use, the passwords being useless thereafter. A client obtains the password from a calculating device, known as a hardware key or dongle, which outputs the passwords (responses) in response to a set of input challenge codes. The dongle may be brought to the kiosk to assist in a transaction, or the responses to a known set of challenges and responses can be written down ahead of time, making it unnecessary to bring the dongle to the transaction session. Because the set of challenges and responses differ for every session according to an algorithm calculated by both the dongle and the kiosk (or a system to which the kiosk is connected), even if an observer views the responses entered by the client, the observer will not be able to use the responses again for authentication.

Although use of one-time passwords improves the security of transactions at public kiosks, it does not affect the privacy of the transactions. A controlled viewing environment improves privacy, but a third party may be able to observe the information that appears on a viewing screen during a transaction. An apparatus and system that can provide the increased security benefits of one-time passwords and can minimize the probability that a party other than an authenticated client can observe the information that appears on the kiosk viewing screen, would enhance both the security and privacy of public kiosk transactions.

### SUMMARY OF THE INVENTION

The present invention provides a pair of optical decryption glasses having one or more lenses that modify incident light emitted from a display so as to render encrypted images appearing on the display that are undecipherable to the naked eye, readable when the screen is viewed through the lenses. The lenses include either diffractive elements such as grating or prisms, or refractive elements. The optical decryption glasses have a unique registration number, and the optical properties of each pair of glasses are also unique to the glasses and associated with its registration number.

In another embodiment, a pair of decryption glasses with processing capabilities is provided. The decryption glasses include an optical sensor, a processor and a display screen. The optical sensor receives images appearing on an external screen that have been encrypted to be undecipherable to the naked eye, and converts the received images into digital data. This data is sent to the processor where it is decrypted, allowing underlying messages to be deciphered and shown on the display screen.

The present invention also provides a system for providing secure and private transactions at public kiosks. The system includes a public kiosk having a processor, a display screen, and an input device. The processor encrypts information that appears on the display screen so that the information is undecipherable to the naked eye. A client views the screen with a pair of decryption glasses which renders the information readable to the client. The client enters a one-time password into the input device, which is authenticated by the kiosk processor. If the one-time password is accepted, the processor employs an encryption algorithm that corresponds to the one-time password entered.

### BRIEF DESCRIPTION OF THE DRAWINGS

FIG. 1 is a schematic illustration of the public kiosk system according to an embodiment of the invention.

FIG. 2 shows a pair of optical decryption glasses according to an embodiment of the invention.

FIG. 3 is a side-view of a lens of a pair decryption glasses that includes diffractive elements according to an embodiment of the invention.

FIG. 4 shows a two letter block of text in which the text is rendered undecipherable due to similar background coloring.

FIG. 5 shows an exemplary 4-by-4 block of text.

FIG. 5a shows an inversion of the exemplary block of text of FIG. 5.

FIG. 6 is a schematic illustration of a lens, particularly pointing out an area of the lens which inverts incoming light according to the invention.

FIG. 7 is a schematic illustration of smart decryption glasses according to an embodiment of the invention.

### DETAILED DESCRIPTION

In accordance with the present invention, information displayed on a viewing screen at a public kiosk is encrypted. The encryption scheme is variable, but is associated with a one-time password (“OTP”) used for registration into the public kiosk system. The encrypted information displayed is viewed and decrypted by a pair of decryption glasses.

In one embodiment of the invention, the pair of decryption glasses is associated with a particular one-time password and is capable of decrypting the displayed image only during a single session. In a related embodiment, the decryption glasses can be reused during a limited number of sessions. These limited-use glasses decrypt the viewed image through optical techniques, such as diffraction and refraction.

In another embodiment, the glasses are equipped with a processor, and can be considered “smart” glasses. These smart glasses receive the input image via an optical character reader, bar code reader, or similar information reading device, and perform decryption operations on the information received. The decryption process corresponds with the encryption process employed by the kiosk system. Accordingly, in this embodiment, the “smart” glasses may be reused indefinitely.

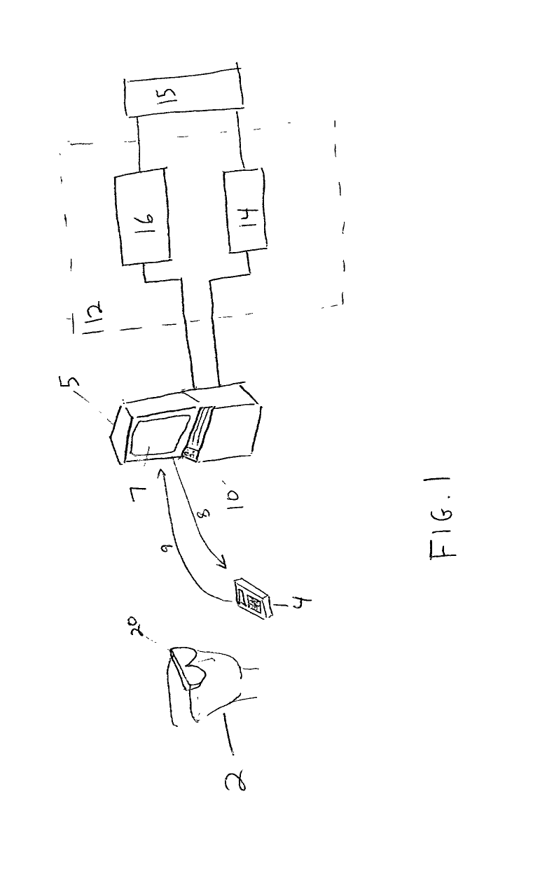

FIG. 1 shows a schematic public kiosk system according to the present invention. A client 2 registers with a public kiosk 5. The client 2 is equipped with a a pair of decryption glasses 20 and may, in an embodiment of the invention, also be equipped with a dongle 4. The kiosk 5 includes a screen 7 and an input device 10, such as a keyboard or number pad. Input information is passed to a processor 12, which includes an authentication module 14 and an encryption module 16, among others. The processor 12 also has access to a storage module 15.

During authentication, the kiosk 5 displays on the screen 7 an alphanumeric challenge 8 issued by the authentication module 14. The client 2, upon viewing the challenge 8, inputs the challenge and a secret pass-phrase into a keypad on the dongle 4. The single challenge and pass-phrase code may be enough to generate an OTP, or alternatively a response 9 may be generated by a processor in the dongle 4. The response 9 is entered back through the keyboard 10 into the kiosk 5, which sends the information to the authentication module 14, which in turn may calculate a new challenge 8. In this manner a series of challenges 8 and responses 9 may occur during authentication.

The challenges 8 and responses 9 are calculated by the authentication module 14 and the dongle respectively by performing multiple iterations of hashing operations on the input alphanumeric codes. The hashing operations apply secure one-way functions to the alphanumeric codes and result in a modified code, from which it is extremely difficult to regenerate the previous code. In one implementation of an OTP system, after each successful authentication, the number of iterations is reduced by one. In this implementation, the number of iterations depends on the number of authentications that have been performed, and a sequence number is stored in storage module 15, to keep track of the number of iterations that will be performed on the next authentication.

The sequence number can be used to determine an encryption scheme for the session. As each session is associated with a unique sequence number, the encryption scheme can be unique for each session. For example, upon completion of an authentication process, the sequence number may be sent to the encryption module 14, which then chooses the preset encryption scheme matched with the sequence number, or uses the number in a calculation to derive various encryption parameters. Alternatively, the encryption scheme can be determined based on an identification number entered into the kiosk 5 during or after authentication which identifies the particular pair of glasses being used to view the screen 7. This latter case may be suitable when optical decryption glasses without processing capability are used, ensuring that the encryption scheme corresponds to the specific decryption functions embedded in the particular pair of glasses. In either case, the encryption module may use Data Encryption Standard (DES) or various other encryption standards to encrypt or conceal the pre-programmed messages that appear on the kiosk screen 7, so that they appear as a blank screen, white noise, or scrambled data to a third-party observer.

The type and degree of encryption depends to some extent on whether optical or smart decryption glasses 20 are used. In general, where smart decryption glasses are used, the encryption scheme can be more complex and extensive. The different types of encryption will be described below in connection with the type of decryption glasses they are most suitably used in conjunction with.

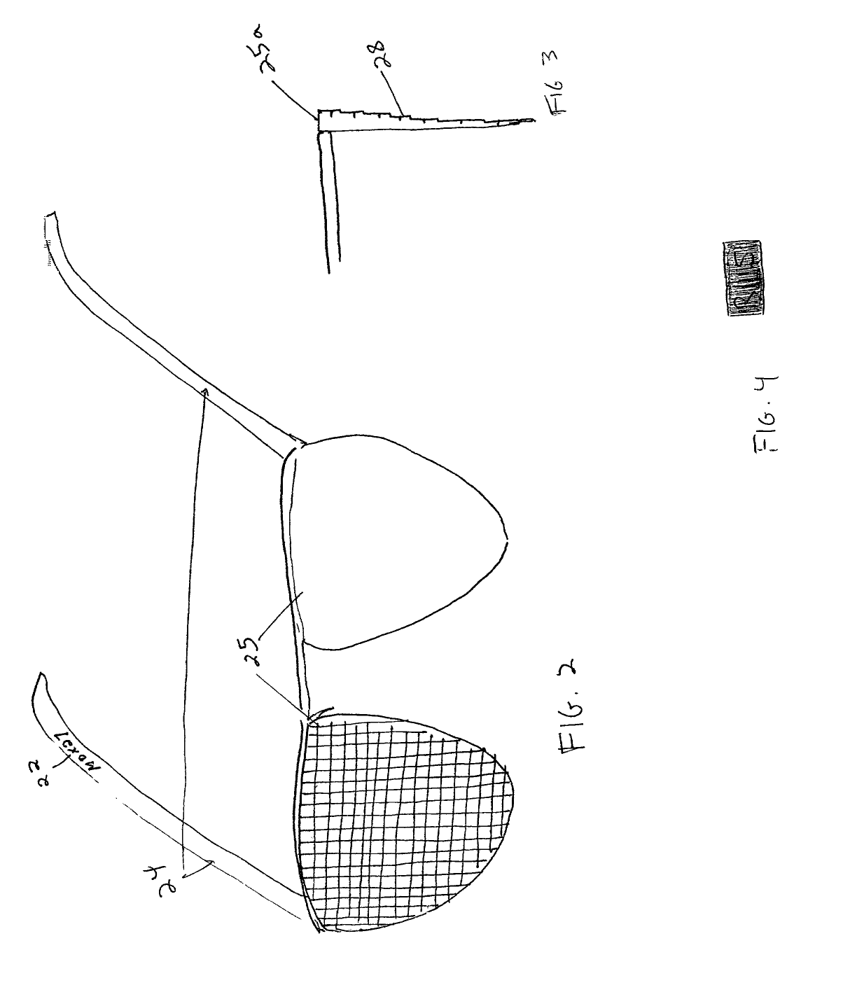

FIG. 2 illustrates a pair of decryption glasses 20 used for optical decryption. An identification number 22 is printed on one or both handles 24 of the glasses 20. The glasses 20 have lenses 25 which receive light emitted by the kiosk screen 7 and modify the incoming light to reverse or compensate for the alterations made to the text messages during the encryption process. One embodiment of optical decryption glasses uses a grid of prisms or diffraction gratings cut into the lens to shift and separate the colors of the received light. FIG. 3 illustrates a lens 25a that contains grid of prism elements 28.

The number of prism elements 28 determines the resolution of the optical decryption. On the highest resolution scale, the array of prism elements 28 may be a pixel-by-pixel mapping of the kiosk screen 7. When the glasses 20 are aligned with the screen 7 correctly, light from each pixel on the screen enters a single prism element 28 and the light is diffracted by an incremental distance. Each element 28 is associated with its own set of diffraction criteria and may diffract light differently from the elements near to or surrounding it.

Lower scale resolution decryption may be employed in lieu of pixel-by-pixel mapping. In this case, there is no correspondence between prism elements and screen pixel elements, but rather a pixel group or block mapping. For instance, the lens 25a may be divided approximately into a square of sixteen blocks, the elements of each block having the same diffraction criteria. Using lower scale resolution implies that similar modifications are made to a block of text during the encryption process. Block encryption provides an advantage of less complex and costly encryption but it may be easier to decipher the underlying message on the screen 7 using this technique.

An implementation of decryption by diffraction is described with reference to FIG. 4. In the figure, a block 30 on the screen 7 two text characters in length is shown. In the example shown, the block contains the letters R and S, but appears as a blank space colored blue to a third party observer. A portion of the pixels which constitute the letters are colored slightly differently from the surrounding blue, but the difference is difficult to detect with the naked eye. If appropriate diffraction glasses are used, the light from the pixels of the letters is diffracted, and the slight color differences are thereby enhanced, making it possible to distinguish the letters R and S from the surrounding blue.

In another embodiment, the decryption glasses 20 use variations in thickness and index of refraction to modify incoming light emitted from the public kiosk screen 7. In this case, the incoming light is refracted, and its path is altered upon contact with the lenses 25 of the decryption glasses 20. In an implementation of refractive optical decryption glasses 20, blocks of text are inverted during encryption and deinverted by the glasses.

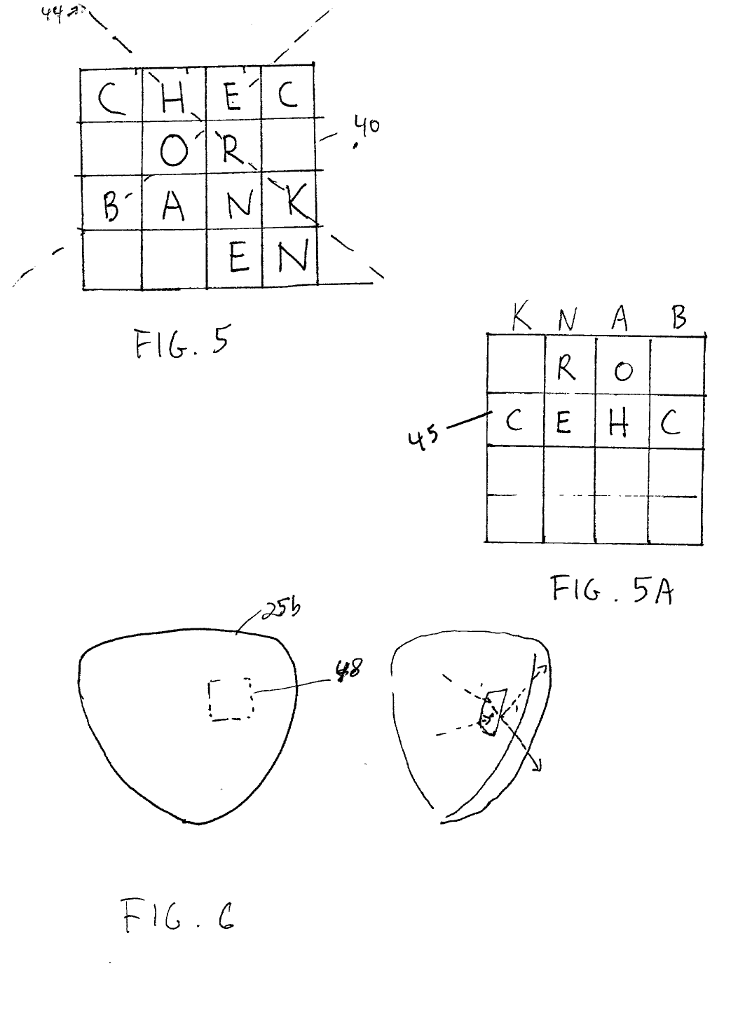

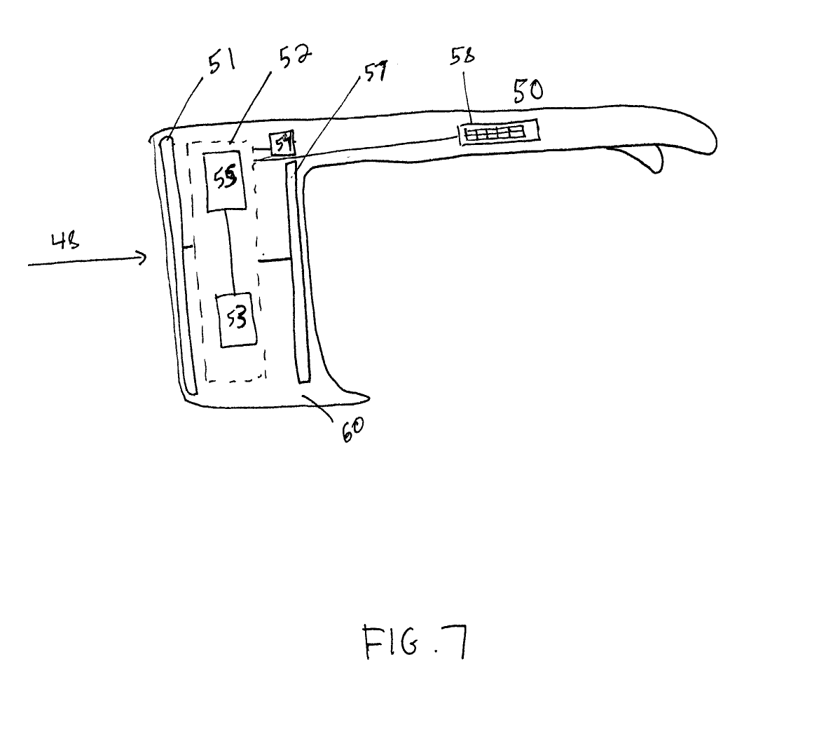

Inversion of the text messages on a kiosk screen is illustrated in FIGS. 5 and 5a. In FIG. 5, a 4-by-4 block of text 40 is shown with two axes of inversion 42 and 44. When inversion along these axes is performed, the block of text is transformed into a modified block 45 shown in FIG. 5a. The text now reads upside down, backwards and is shifted upwards by two lines of text. Although the inversion shown can be reconstructed by an observer, different axes of inversion may be applied to areas of the screen, making the overall process of reconstructing the text difficult and time consuming.

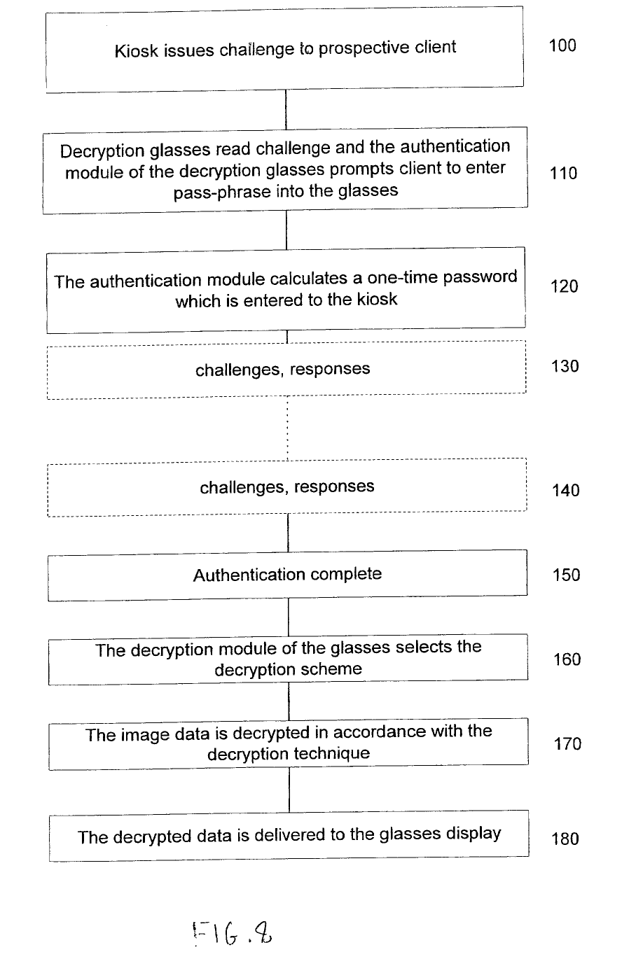

FIG. 6 shows a refractive lens 25b of a pair of optical decryption glasses according to an embodiment of the invention. An area of the lens receives light corresponding to the block of text 45 shown in FIG. 5a. The area of the lens 48 has optical properties that cause the light to be inverted along axes that correspond to the inversion used in the encryption process, resulting in a reconstruction of the original text. The specific optical properties are caused by variations in the thickness of the area and different refraction indices of materials that may be incorporated into the lens 25b.

Decryption glasses may also include processing capabilities for decryption and reconstruction of images. FIG. 7 is a schematic illustration of a pair of smart decryption glasses 50. An optical character reader (“OCR”) 51 receives and digitizes images received from the kiosk 5 into image data. The digitized image information is sent to a processor 52. The processor includes an authentication module 53, which performs processing tasks similar to the tasks performed by the dongle 4 described above, and a decryption module 55 which decrypts the image data according to an algorithm that corresponds to the encryption algorithm used at the kiosk encryption module 16. Memory module 54 stores information such as the sequence number of the transaction/authentication session. A miniature keypad 58 on the frame of the glasses 50 can be used to input a pass phrase or number. Decrypted image data is processed and sent to the glasses display 57, which may be for example, an LED display fitted to the visor 60 of the glasses 50.

A transaction process is described with reference to FIG. 8. When a transaction at a kiosk 5 begins, in step 100, a challenge 8 that appears on the kiosk display is read and digitized by OCR 51, which sends the information to the authentication module 53. In step 110, the authentication module 53 sends a prompt signal to the glasses display 57 requesting the client 2 to enter a pass-phrase. The client 2, enters a secret pass-phrase on the glasses keypad 58, and the authentication module 53 calculates a response 9 based upon the challenge 8 and the pass-phrase, which the client 2 then enters onto the keypad 10 of the kiosk 5 (step 120). A series of challenges 8 and responses 9 may follow, in steps 130 and 140 before authentication is complete (step 150). Successful authentication confirms the sequence number stored in memory module 54 because the number of hash-function iterations matches between the kiosk system and the decryption glasses.

In step 160, the decryption module 55 reads the sequence number, and selects the stored decryption scheme associated with the sequence number. The image data appearing on the kiosk screen 5 that is read and converted by the OCR 51 is sent to the decryption module which transforms the data, in step 170, according to the decryption technique. The resulting decrypted data is then delivered to the glasses display 57 (step 180).

A multitude of encryption-decryption techniques may be used in conjunction with smart decryption glasses. The techniques described below are exemplary and are not to be taken as a limitation on the encryption-decryption schemes that may be used in the context of the present invention. For example, in one embodiment, a series of code symbols such as asterisks or icons can appear on the kiosk display 7. Each symbol may correspond one-to-one with an alphanumeric character, or the correspondence may be more complex and dynamic, so that a symbol can represent one alphanumeric in one screen location, and another in a different location. The decryption module 55 applies the algorithm to the symbol data received by the OCR 51 and converts them into the corresponding alphanumeric character which is then shown in the glasses display 57.

In another embodiment, alphanumeric text may appear on the kiosk screen 7 in scrambled form, again according to an algorithm shared between the encryption module 16 of the kiosk 5 and the decryption module 55 of the smart decryption glasses 50. A pre-programmed message is scrambled by the encryption module and appears as incoherent text at the kiosk display 5. The decryption module 55 of the glasses 50 de-scrambles the text, reversing the scrambling algorithm.

In still another embodiment, bar codes are used on the kiosk display. The thickness of each bar code corresponds to an alphanumeric character. Text words appear as a series of bar codes on the kiosk screen 7. In this case the OCR 51 may be replaced with a conventional bar code reader. Encryption and decryption still may be employed on the bar code information as an added security measure. The bar code reader determines the length of the bars on the screen, the processor 52 translates the thickness data into alphanumeric code which then may be decrypted in accordance with the techniques mentioned.

In addition, steganographic methods may be employed to hide the messages shown on the kiosk screen. The kiosk screen may appear as a grid of colored boxes, or black, white and grey boxes on a black-and-white screen. Taking the latter as an example, let us assume boxes are regularly given 11 grey-scale values of 0, 10, 20 . . . 100, 0 being pure black and 100 pure white. The naked eye can distinguish between these 11 colors on a continuum from black to white, but may not be able to distinguish between values of say, 70 and 77. An optical sensor analogous to an OCR 51 may be able to distinguish between these values, and can therefore receive “hidden” information that the eye cannot discern. This extra color information can be used to design a steganographic encryption scheme. Using the example provided each level of the grey-scale from 0 to 100 can be associated with an alphanumeric character. The mapping between the color levels and the characters may be stored in the storage and memory modules 15, 54 of the kiosk 5 and decryption glasses 50 respectively. The encryption module 16 converts text to color scale levels and the decryption module 55 converts the color levels measured by the optical sensor into alphanumeric characters.

In the foregoing description, the apparatus and system of the present invention have been described with reference to a number of examples that are not to be considered limiting. Rather, it is to be understood and expected that variations in the principles of the method and apparatus herein disclosed may be made by one skilled in the art and it is intended that such modifications, changes, and/or substitutions are to be included within the scope of the present invention as set forth in the appended claims. For example, although only diffractive and refractive embodiments of optical decryption have been described, it is understood that other optical principles, such as polarization may be used to modify text images displayed at a kiosk. The specification and the drawings are accordingly to be regarded in an illustrative rather than in a restrictive sense.

What is claimed is:

1. A pair of optical decryption glasses, comprising:
a pair of lenses, the lenses modifying incident light emitted from a display so as to render encrypted images appearing on the display that are undecipherable to a naked eye, readable when the screen is viewed through the lenses; and
a frame.

2. The optical decryption glasses of claim 1, further comprising:
a registration number printed on the frame by which the optical decryption glasses are identified.

3. The optical decryption glasses of claim 2, wherein the lenses include at least one of diffraction gratings and miniature prisms, each of the at least one of diffraction gratings and prism having different diffraction criteria.

4. The optical decryption glasses of claim 3, wherein a map of the diffraction criteria of the at least one of diffraction gratings and miniature prisms over a surface of the lens, is unique and associated with the registration number.

5. The optical decryption glasses of claim 2, wherein the lenses include variations in at least one of thickness and index of refraction.

6. The optical decryption glasses of claim 5, wherein a map of variations in at least one of thickness and index of refraction over a surface of the lens, is unique and associated with the registration number.

7. Decryption glasses, comprising:
an optical sensor;
a processor; and
a display screen;
wherein the optical sensor receives images appearing on an external screen that have been encrypted to be undecipherable to a naked eye, converts the received images into digital data and sends the data to the processor, the processor decrypts the data, and sends readable images to the display screen.

8. The decryption glasses of claim 7, wherein the processor includes:
an authentication module; and
a decryption module.

9. The decryption glasses of claim 8, further comprising:
a memory module;
wherein the memory module stores a parameter, the parameter determining an algorithm used by the encryption module to decrypt data received from the optical sensor.

10. The decryption glasses of claim 7, wherein the optical sensor is an optical character reader.

11. The decryption glasses of claim 7, wherein the optical sensor is a bar code reader.

12. The decryption glasses of claim 7, wherein the optical sensor measures color levels appearing on the external screen.

13. The decryption glasses of claim 8, further comprising:
a keypad;
wherein a code entered into the keypad is processed by the authentication module and used to calculate a password, the password providing access to the information displayed on the external screen.

14. A system for providing secure and private transactions at public kiosks, comprising:
a public kiosk, including:
a processor; and
a display screen; and
a pair of decryption glasses;
wherein the processor of the public kiosk encrypts information that appears on the display screen so that the information is undecipherable to a naked eye, and the decryption glasses, when worn by a viewer, render the information readable for the viewer.

15. The public kiosk system of claim 14, wherein the public kiosk system further includes an input device;
wherein a viewer using the decryption glasses registers with the public kiosk by entering authentication information into the input device, the authentication information being reviewed by the kiosk processor which determines whether to provide the viewer access to displayed information based on the authentication information.

16. The public kiosk system of claim 15, wherein the authentication information is a one-time password.

17. The public kiosk system of claim 16, wherein the one-time password is associated with a registration number inscribed on the decryption glasses.

18. The public kiosk system of claim 16, wherein an encryption algorithm used by the kiosk processor to encrypt displayed information corresponds to the one-time password entered by the viewer.

19. A method of providing secure and private transactions at public kiosks, comprising the steps of:
authenticating a prospective client attempting to use the public kiosk;
if the client is authenticated, encrypting image data appearing on a kiosk display so that they are undecipherable to a naked eye;
viewing the kiosk display using a pair of decryption glasses; and
decrypting the image data using the decryption glasses, rendering the image data readable for the viewer.

20. The method of claim 19, wherein a client is authenticated by inputting an appropriate one-time password into the public kiosk.

21. The method of claim 19, wherein the decryption occurs due to optical properties of lenses of the decryption glasses.

22. The method of claim 19, wherein the decryption is performed by a processor.
